(19) United States
(12) Patent Application Publication
(10) Pub. No.: US 2005/0157669 A1
(43) Pub. Date: Jul. 21, 2005

(54) Broadcast/multicast services in communications networks

(76) Inventors: Mang Zhu, Vernon Hills, IL (US); Hao Bi, Wheeling, IL (US)

Correspondence Address: MOTOROLA INC, 600 NORTH US HIGHWAY 45, ROOM AS437, LIBERTYVILLE, IL, 60048-5343, US

(21) Appl. No.: 10/748,032

(22) Filed: Dec. 30, 2003

(51) Int. Cl. H04H 1/00

(52) U.S. Cl. 370/312; 370/311; 340/7.46; 340/7.34

(57) ABSTRACT

A method in a wireless broadcast/multicast service subscriber systems including selecting (410) a paging slot for communicating broadcast/multicast subscriber information, communicating (420) broadcast/multicast identification information corresponding to the slot on which broadcast/multicast subscriber information may be obtained by a broadcast/multicast service subscriber device, and communicating broadcast/multicast service information on the paging slot selected (430). Subscriber devices obtain the broadcast/multicast information using the slot identified by the identification information.

### FIELD OF THE DISCLOSURE

The present disclosure relates generally to broadcast/multicast services in communications network, and more particularly to providing broadcast/multicast service information in paging slots identified using broadcast/multicast identification information communicated to broadcast/multicast service subscribers, for example, to mobile subscribers in wireless communications networks, and methods.

### BACKGROUND

Broadcast/multicast communication service (BCMCS) is the simultaneous transmission of the same information to multiple recipients. BCMCS transmission on shared data channels is a relatively efficient allocation of radio resources in comparison to using multiple dedicated channels to communicate the same information to multiple recipients. Any data may be transmitted in broadcast/multicast service, including but not limited to text, multimedia, streaming media, etc.

Broadcast/multicast (BCMC) services were introduced to cellular communications systems to simultaneously provide information, for example, emergency and other information, to multiple mobile stations subscribed to the broadcast/multicasting service. Some wireless communications standards organizations have adopted protocols for providing broadcast/multicast services to mobile subscriber devices in wireless communications networks. The 3^{rd} Generation Partnership Project 2 (3GPP2), for example, has defined the functionality of broadcast multicast services that may be incorporated in to CDMA2000 based wireless telecommunications networks in the Broadcast/Multicast Services—Stage 1, Revision A, 3GPP2 S.R0030-A, Version 1.0. Other standards may specify the broadcast multicast functionality for other wireless communications protocols.

Currently, the system does not notify or page the broadcast/multicast service subscriber devices when the broadcast/multicast service becomes available. Thus the mobile station must constantly monitor for the broadcast/multicast service. Monitoring for multicast/broadcast service availability however consumes power.

In CDMA 1×EV-DO, it has been proposed for the broadcast/multicast subscriber device to monitor the EVDO channel for broadcast/multicast service availability information. Under this CDMA 1×EV-DO proposal, however, the mobile station is not in a power conserving idle state when monitoring the EV-DO channel.

In many cellular communications systems, wireless mobile stations, also referred to as user equipment, registered with the network remain in an idle state until the mobile station requires network access, for example, to make an outgoing call, obtain a data connection, etc., or until the mobile station receives a page from the network. Power consumption is reduced when the mobile station is in the idle state.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary wireless communications network in which broadcast/multicast services are provided to mobile wireless subscriber devices.

FIG. 2 is a diagram of a process for providing broadcast/multicast service information to broadcast/multicast subscriber devices.

FIG. 3 illustrates an exemplary paging channel slot structure in which broadcast/multicast service information may be provided to subscribers.

FIG. 4 is a diagram of a process for selecting paging slots for providing broadcast/multicast service information to broadcast/multicast subscriber devices.

### DETAILED DESCRIPTION

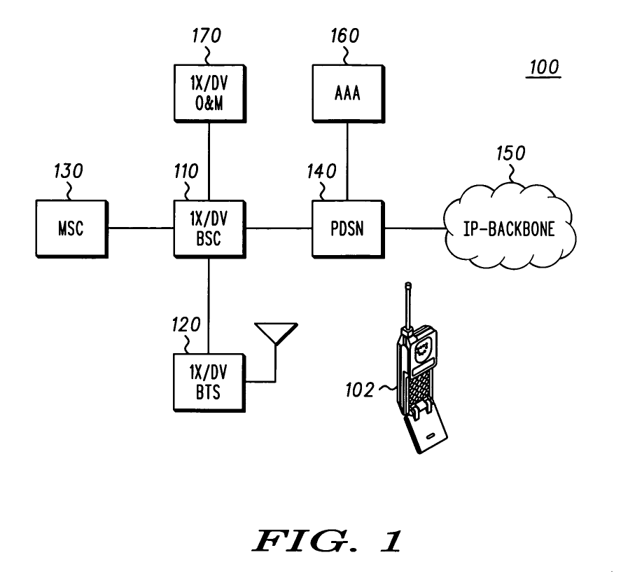

FIG. 1 illustrates an exemplary CDMA 2000 1× Evolution for Data and Voice (1×EV-DV, also known as CDMA2000, release C) services wireless communications network 100 comprising generally a base station controller (BSC) 110 communicably coupled to one or more base transceiver stations (BTS) 120 and to a mobile switching center (MSC) 130. The exemplary network 100 also comprises a Packet Data Serving Node (PDSN) 140 communicably coupled to an IP backbone 150 or to some other network. The exemplary PDSN is also communicably coupled to an Authentication, Authorization and Accounting (AAA) entity 160, and the BSC 110 is communicably coupled to a 1× Evolution—DV Operations and Maintenance (O&M) entity 170. In other embodiments, more generally, the network is some other network that provides broadcast/multicast services, for example, a CDMA2000 High Rate Packet Data (HRPD) network, or some other network. CDMA HRPD was known formerly as CDMA 1× Evolution—Data Only (1×EV-DO) and High Data Rate (HDR) (high-speed data-only version CDMA network). Although the exemplary network infrastructure architecture is wireless, the disclosure is also applicable to wire-line broadcast/multicast service applications.

In FIG. 1, an exemplary wireless broadcast/multicast subscriber device 102 receives broadcast/multicast services from one or more base stations, for example, the exemplary BTS 120 in FIG. 1, as the broadcast/multicast subscriber device 102 moves about the network. In other embodiments, the broadcast/multicast subscriber device is not necessarily a wireless device.

In the exemplary wireless communications system, the broadcast/multicast service is originated from a content server. In some networks, the content server is part of the base-transceiver station 120 in FIG. 1, but more generally the content server is a network entity that communicates with the base transceiver station 120. The content server may be located at a base station controller 110, at a network controller, or at some other network entity, or it may be a standalone server attached to the network. Broadcast/multicast services are also provided in networks other than wireless communications networks.

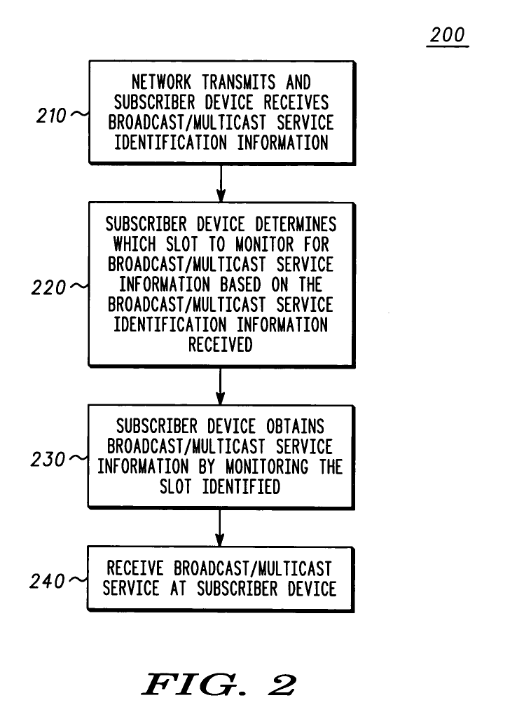

In the exemplary process diagram 200 of FIG. 2, at block 210, the network, for example, BTS 120 in FIG. 1, transmits broadcast/multicast service identification information to a broadcast/multicast subscriber device, for example, wireless mobile station 102 in FIG. 1. In one embodiment, the broadcast/multicast service identification information is communicated to subscriber devices in an overhead message, for example, the Primary Broadcast Control Channel of the exemplary CDMA2000 1×EV-DV services wireless communications network. Alternatively, the broadcast/multicast service identification information is communicated to one or more subscriber devices in corresponding dedicated messages. The subscriber device obtains the broadcast/multicast service identification information upon decoding the channel on which the message is contained.

In FIG. 2, at block 220, the subscriber device uses the broadcast/multicast identification information to determine which slot in a common control channel to monitor for broadcast/multicast service information. In the exemplary CDMA2000 1×EV-DV services wireless communications network 100 of FIG. 1, the subscriber devices uses the broadcast/multicast identification information received from the base station to determine which slot to monitor on the quick paging channel (QPCH) or on the paging channel (PCH) or on the Forward Common Control Channel (F-CCCH). Generally, the mobile station monitors the Quick paging channel to determine whether it should receive messages from the paging channel or the Forward Common Control Channel.

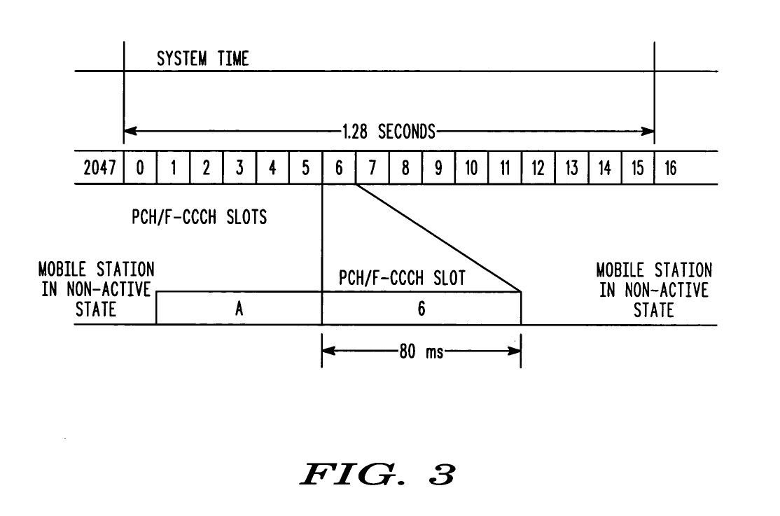

FIG. 3 illustrates exemplary 1×EV-DV PCH/F-CCCH slots 0-2047. The exemplary PCH/F-CCCH slots are 80 ms and are monitored by the subscriber device in the idle state so that the subscriber device can receive messages, receive incoming calls, and initiate calls, registrations, message transmissions, etc. Generally, subscriber devices operating in slotted mode monitor only the slot or slots to which it is assigned, for example, one or two slots per cycle, whereas subscriber devices operating in non-slotted mode monitor all slots. In some communications systems, the subscriber device may also optionally monitor additional slots to receive broadcast messages and/or broadcast pages. FIG. 3 illustrates the mobile station subscriber in the active and inactive states while monitoring a PCH/F-CCCH slot. See, for example, 3GPP2 C.S0005-C, 2.6.2.1 Idle Procedures.

In FIG. 2, at block 230, the subscriber device obtains broadcast/multicast service information by monitoring the slot identified by the broadcast/multicast identification information. In some embodiments, for example, broadcast/multicast service information is indicative of the availability of the broadcast/multicast service, the time and channel where the service may be obtained, changes in broadcast/multicast service availability, etc. In some embodiments, the broadcast/multicast service information is contained in the slot, and in other embodiments, the slot contains a pointer or other information indicating where the broadcast/multicast service information may be obtained.

In FIG. 2, at block 240, the broadcast/multicast subscriber device receives available broadcast/multicasting service after receiving the paging information providing information, e.g., time and channel information, about the broadcast/multicast service.

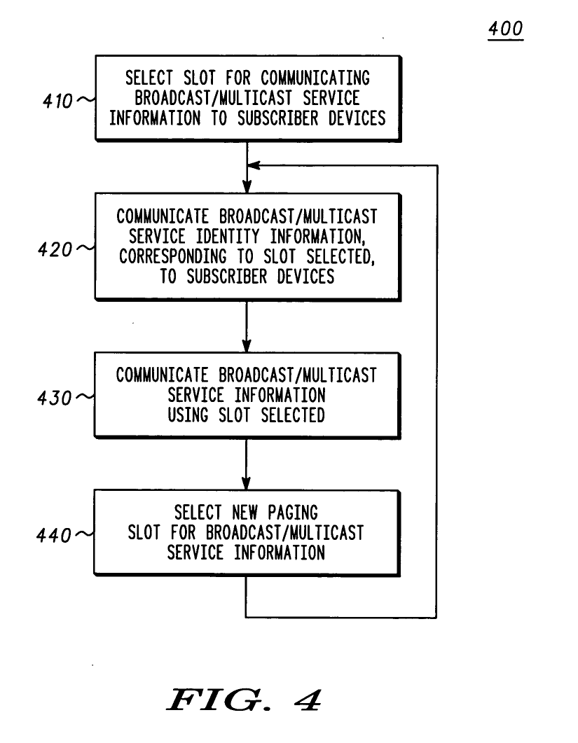

In the process diagram 400 of FIG. 4, at block 410, in the network, for example, at the base transceiver station 120 of FIG. 1, a paging slot is selected for transmitting broadcast/multicast service information to one or more broadcast/multicast subscriber devices. This information could be transmitted over an overhead broadcast channel or one or more dedicated channels or some other channel. In some applications, for example, in the exemplary CDMA2000 1×EV-DV services wireless communications network, the slot is determined based identification information and a hashing function.

In one embodiment, the paging slot selected is one less likely than other paging slots to be monitored by non-subscribers of a broadcast/multicast service. In other embodiments, the broadcast/multicast service identification information is changed dynamically in the system in order to allow the paging slot to beselected or changed dynamically in response to changes in network conditions, e.g., in response to the reallocation of paging slots assigned to broadcast/multicast service subscriber devices and non-subscriber of said services, so that the slot selected remains less likely than others to be monitored by non-subscribers of a broadcast/multicast service.

In FIG. 4, at block 420, the network, for example, the BTS 120 in FIG. 1, communicates broadcast/multicast service identity information to one or more subscribers of the corresponding broadcast/multicast service. The broadcast/multicast service identity information is used by the subscriber devices for identifying the paging slot selected at bock 410, for example, by using the hashing function to obtain a corresponding paging slot number.

In FIG. 4, at block 430, the network, for example, the BTS 120 in FIG. 1, communicates broadcast/multicast service information on the determined paging slot, which is known to the broadcast/multicast service subscribers by virtue of the broadcast/multicast service identity information. As noted above, the paging slot may include broadcast/multicast service information indicating the availability of, or changes in, broadcast/multicast services, the time and channel on which the broadcast/multicast service will be available, etc. Alternatively, the paging slot may indicate where the broadcast/multicast service information may be obtained, for example, on a broadcast channel or in some other location.

In FIG. 4, at block 440, the network dynamically selects a new paging slot for communicating broadcast/multicast service information. In some embodiments, for example, the new broadcast/multicast information service slot is selected in response to changing paging slot assignments to broadcast/multicast subscriber and non-subscribers. In FIG. 4, the process proceeds from block 440 to block 420 where the broadcast/multicast service identity information corresponding to the new paging slot selected at block 440 is communicated to the subscriber device.

While the present disclosure and the best modes thereof have been described in a manner establishing possession by the inventors and enabling those of ordinary skill in the art to make and use the same, it will be understood and appreciated that there are equivalents to the exemplary embodiments disclosed herein and that modifications and variations may be made thereto without departing from the scope and spirit of the disclosure, which is to be limited not by the exemplary embodiments but by the appended claims.

1. A method in a wireless broadcast/multicast service subscriber device, the method comprising:
determining a slot to monitor for paging information;
obtaining broadcast/multicast service information by monitoring the slot for paging information indicating the availability of the broadcast/multicast service.

2. The method of claim 1,
obtaining broadcast/multicast service identification information,
determining the slot to monitor based on the broadcast/multicast service identification information.

3. The method of claim 2,
obtaining the broadcast/multicast service identification information from a wireless message received by the wireless broadcast/multicast service subscriber device.

4. The method of claim 2, obtaining the broadcast/multicast service identification information from a system overhead message received by the wireless broadcast/multicast service subscriber device.

5. The method of claim 2,
obtaining updated broadcast/multicast service identification information,
determining a new slot to monitor based on the updated broadcast/multicast service identification information,
determining broadcast/multicast service availability by monitoring the new slot for paging information indicating the availability of the broadcast/multicast service.

6. The method of claim 5, obtaining the broadcast/multicast service identification information in a message received at the wireless broadcast/multicast service subscriber device.

7. The method of claim 1, obtaining broadcast/multicast service information includes determining the availability of the broadcast/multicast service.

8. The method of claim 1, obtaining broadcast/multicast service information from the slot monitored.

9. The method of claim 1, obtaining broadcast/multicast service information from a source referenced in the slot monitored.

10. A method in a wireless broadcast/multicast service subscriber device, the method comprising:
receiving paging information indicating broadcast/multicast service information;
receiving the available broadcast/multicasting service after receiving the paging information indicating the availability of the broadcast/multicast service information.

11. The method of claim 10, receiving paging information indicating broadcast/multicast service information includes receiving the broadcast/multicast service information in a paging slot.

12. The method of claim 10, receiving paging information indicating broadcast/multicast service information includes determining where to obtain broadcast/multicast service information using information in a paging slot.

13. A method in a wireless communications network providing broadcast/multicast services, the method comprising:
determining a paging slot;
sending a broadcast/multicast service identity to subscribers of a corresponding broadcast/multicast service,
the broadcast/multicast service identity identifying the determined paging slot;
sending broadcast/multicast service information on the determined paging slot.

14. The method of claim 13,
determining the paging slot includes selecting a paging slot less likely than other paging slots to be monitored by non-subscribers of a broadcast/multicast service.

15. The method of claim 13,
determining a new paging slot;
sending a new broadcast/multicast service identity to subscribers of the broadcast/multicast service, the new broadcast/multicast service identity identifying the new paging slot;
sending broadcast/multicast service information on the new paging slot.

16. The method of claim 15, determining the new paging slot includes selecting a paging slot less likely than other paging slots to be monitored by non-subscribers of a broadcast/multicast service.

17. The method of claim 13, determining the broadcast/multicast identity based on a hash function.

18. A method in a wireless communications network providing broadcast/multicast services, the method comprising:
dynamically selecting a paging slot for communicating broadcast/multicast subscriber information;
communicating broadcast/multicast identification information corresponding to the slot on which broadcast/multicast subscriber information may be obtained by a broadcast/multicast service subscriber device,
communicating broadcast/multicast service information on the paging slot selected.

19. The method of claim 18, dynamically selecting the paging slot for communicating broadcast/multicast subscriber information includes selecting a paging slot less likely than other paging slots to be monitored by non-subscribers of broadcast/multicast service.

20. The method of claim 18, transmitting broadcast/multicast service identification information indicating the paging information slot where the paging information is located.

21. The method of claim 17,dynamically selecting a new paging slot for communicating broadcast/multicast subscriber information,
transmitting new broadcast/multicast identification information corresponding to the new slot on which broadcast/multicast subscriber information may be obtained by a broadcast/multicast service subscriber device.
providing broadcast/multicast service information on the new paging slot selected;
